(19) United States
(12) Patent Application Publication
(10) Pub. No.: US 2010/0012606 A1
(43) Pub. Date: Jan. 21, 2010

(54) URN AND URN SYSTEM

(76) Inventor: Henry M. Bourgo, Las Vegas, NV (US)

Correspondence Address: GREENBERG TRAURIG (LV), 3773 HOWARD HUGHES PARKWAY, Suite 400 North, LAS VEGAS, NV, 89169, US

(21) Appl. No.: 12/503,587

(22) Filed: Jul. 15, 2009

Related U.S. Application Data
(60) Provisional application No. 61/081,161, filed on Jul. 16, 2008.

(51) Int. Cl. A61G 17/08; A61G 17/00

(52) U.S. Cl. 211/85.27; 27/1

(57) ABSTRACT

An urn system includes means for configuring memorials tributes with urns as the centerpiece. Urns include cut-outs for receiving independent flanges or flanges connected to other elements or secondary members including other urns, display cases, frames, inscription plates, insert holders and the like. Each of the secondary members allows a substantive memorial to be created with numerous decorative and inspirational elements. Multiple urns can be linked to one another as well.

### CROSS-REFERENCE

This application claims the benefit of U.S. Provisional Application No. 61/081,161 filed Jul. 16, 2008.

### FIELD OF THE INVENTION

The embodiments of the present invention relate to an urn system wherein multiple urns may be connected to one another and/or a rigid surface (e.g., wall or supportive item).

### BACKGROUND

Urns take on many shapes and sizes, and are fabricated of numerous types of materials including wood, alloys, and plastics. Considering their purpose, conventional urns are essentially static and subdued in nature. However, there are situations in which it would be desirable to enhance an urn system such that multiple urns may be connected to one another to create a more dynamic presentation and tribute. Advantageously the urn should be configured for connection to a wall or other rigid structure.

Moreover, urns have not been decorative or configurable with pieces of memorabilia associated with the deceased. Such features provide a more versatile urn system which may be tailored to celebrate the deceased.

Thus, there exists a need for a more dynamic urn system. Advantageously, the urn system should be expandable, reconfigurable, decorative and attachable to rigid surfaces, like a wall or other supportive item.

### SUMMARY

Accordingly, a first embodiment of the present invention is an urn comprising: a housing defining an interior space, said housing having at least one opening for accessing the interior space; closure means adapted to close said at least one opening; and one or more cut-outs on one or more exterior surfaces of said housing, said one or more cut-outs configured to receive flanges of secondary members.

Another embodiment is an urn system comprising: a first urn connected to one or more of the following secondary members: one or more additional urns, one or more segments, one or more display cases, one or more brackets, one or more flange inserts, one or more inscription plates, one or more frames; and wherein said connection between said first urn and said secondary members is accomplished by mating flanges of said secondary members with corresponding cut-outs in one or more exterior surfaces of said first urn.

Another embodiment is an urn comprising: housing defining an interior space, said housing having at least one opening for accessing the interior space; one or more end caps configured to attach to ends of the housing wherein at least one end cap serves to open and close said at least one opening; and wherein at least one of said end caps is configured to retain items of interest.

The embodiments of the present invention allow a tribute comprising one or more urns to be easily created and altered using an urn attachment system. In addition, other decorative items, including frames, display cases, insert holders, accent rings and the like, may be connected to expand the tribute.

Other variations, embodiments and features of the present invention will become evident from the following detailed description, drawings and claims.

### BRIEF DESCRIPTION OF THE DRAWINGS

FIGS. 1a and 1b illustrate perspective views of a square urn according to the embodiments of the present invention;

FIG. 2 illustrates an urn bracket adapted to attach a first urn to a second urn, or other attachment members;

FIG. 3 illustrates the urn bracket of FIG. 2 being inserted into slots on an exterior surface of an urn;

FIG. 4 illustrates a wall bracket adapted to receive the urn bracket;

FIG. 5 illustrates a perspective view of a circular style urn according to the embodiments of the present invention;

FIGS. 6a-6b illustrate urn brackets configured to attach urns to one another;

FIGS. 7a-7b illustrates a perspective view of a circular style urn with and without decorative features in place;

FIG. 8 illustrates a canister for containing artifacts and remains and configured for positioning within a circular urn;

FIGS. 9a-9b illustrate specialized end caps/lids;

FIG. 10 illustrates a frame member configured for placement between two urns;

FIGS. 11a-11b illustrate an inscription plate separately and in position on an urn;

FIGS. 12a-12c illustrate various display cases for attachment to the urns; and

FIGS. 13a-13c illustrate a series of flange inserts.

### DETAILED DESCRIPTION

It will be appreciated by those of ordinary skill in the art that the invention can be embodied in other specific forms without departing from the spirit or essential character thereof. The presently disclosed embodiments are therefore considered in all respects to be illustrative and not restrictive.

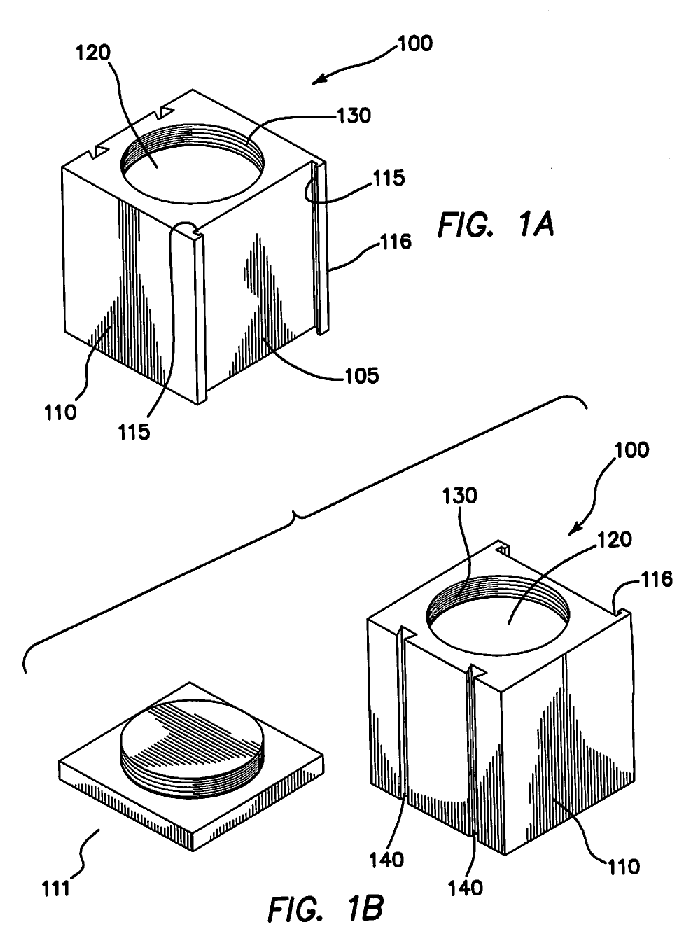

Initial reference is made to FIGS. 1a and 1b illustrating an urn 100 according to the embodiments of the present invention. The urn 100, as shown, is substantially in the shape of a cube but any shape and size is possible within the spirit and scope of the present invention. Housing 110 defines an interior space 120 for receipt of items, including keepsakes and ashes, related to a person being memorialized. A threaded opening 130 in the housing 110 is accessed and closed by receiving a threaded lid 111.

One exterior surface of the urn 100 defines a recess 105 configured to receive a photo, paper or similar flat article. A pair of spaced slots 115 defined by protrusions 116 receive and retain a properly dimensioned photo, paper or similar article. While the recess 105, slots 115 and protrusions 116 are shown on one exterior surface of the urn 100 only, it is understood that multiple exterior surfaces of the urn 100 can define such a recess 105 and include slots and protrusions for retaining a flat article.

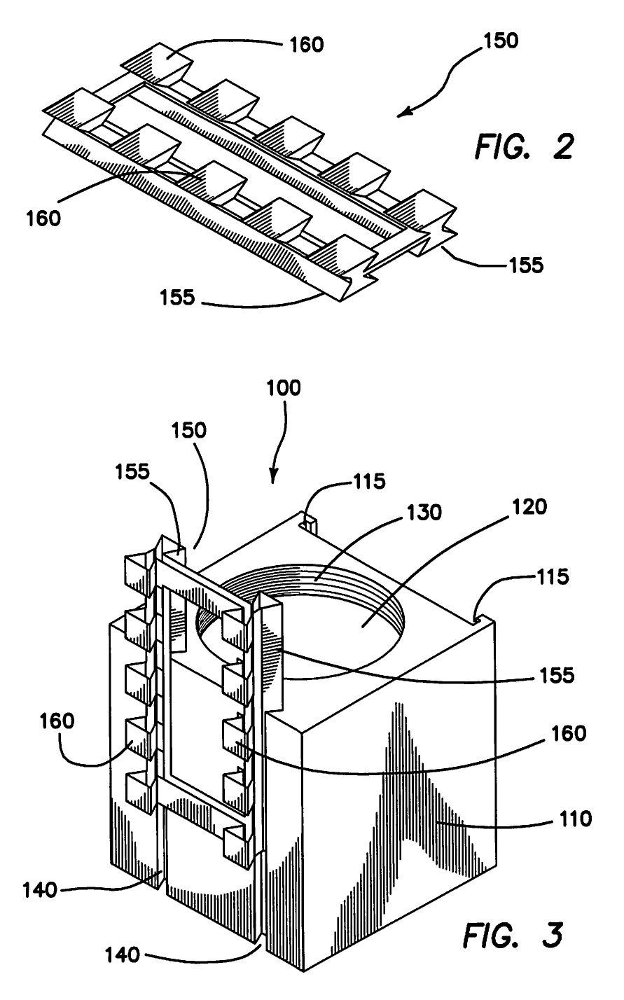

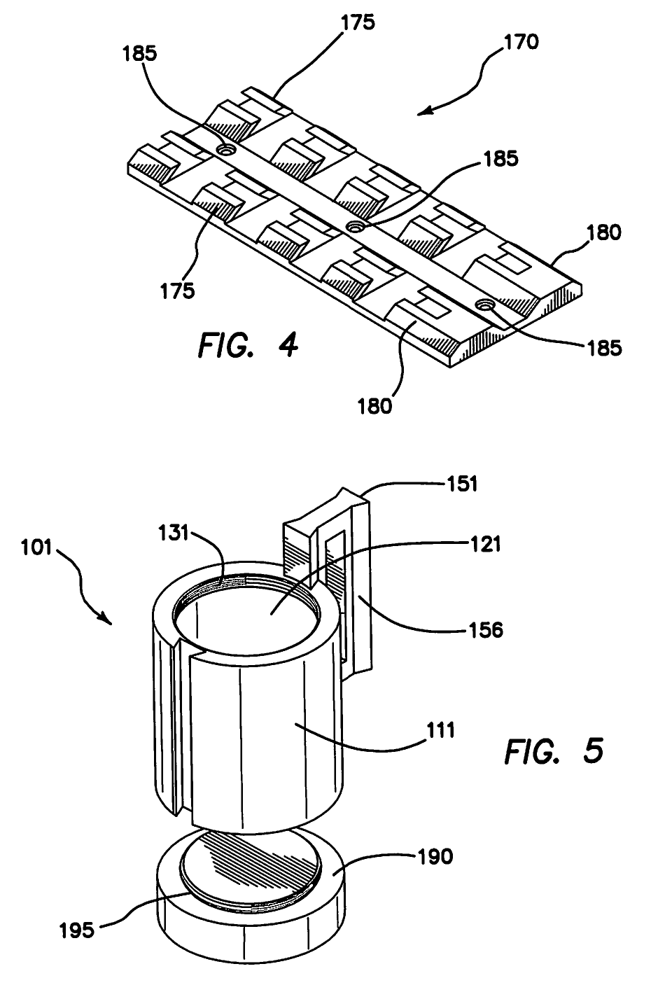

Another exterior surface of the urn 100 includes a pair of spaced cut-outs 140 extending along a height thereof. The cut-outs 140 are configured to receive a bracket member 150 as shown in FIG. 2. The bracket member 150 comprises a pair of spaced, elongated protrusions 155 with cross-sections matching the cross-section of the cut-outs 140. FIG. 3 shows the bracket member 150 partially inserted into the cut-outs 140.

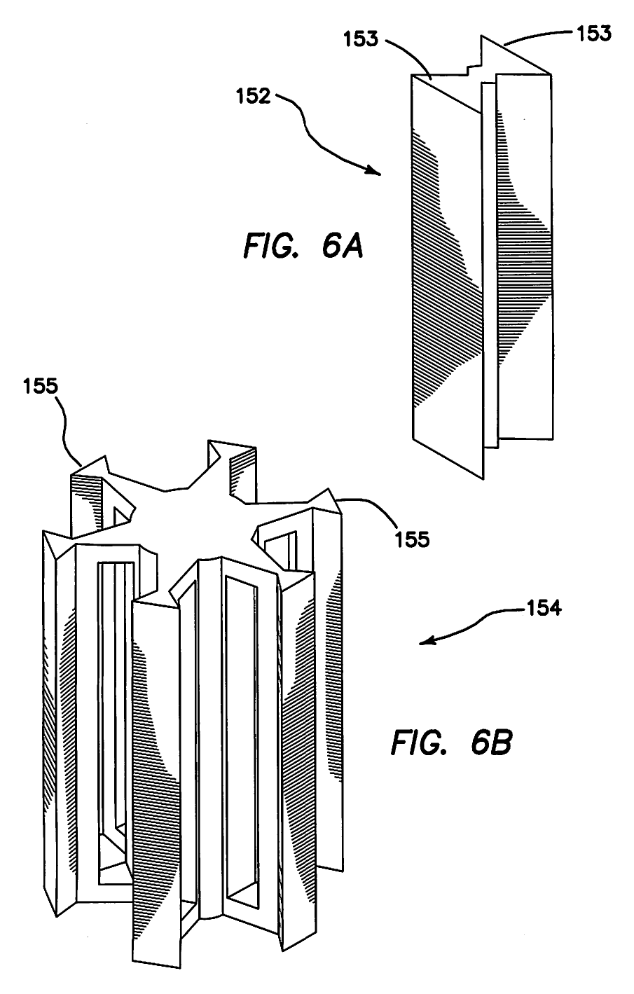

Opposite the elongated protrusions 155 are two rows of teeth 160 joined in a parallel fashion. The teeth 160 are configured for attachment to a wall bracket member 170 shown in FIG. 4. The wall bracket member 170 comprises two rows of parallel, individual slot members 175. A receiving slot member 180 is positioned at an end of each row of slot members 175. In practice, the two rows of teeth 160 are received by the defined slot members 175 and receiving slot members 180 to attach the urn 100 to a wall or similar rigid member. The wall bracket member 170 includes three countersunk openings 185 for receipt of screws, nails or similar fastening means for attaching the wall bracket member 170 to a wall or similar rigid surface or item.

In another embodiment, the bracket member 150, as shown in FIG. 2, is symmetric consisting of back-to-back pairs of spaced elongated protrusions such that multiple urns 100 may be connected to one another.

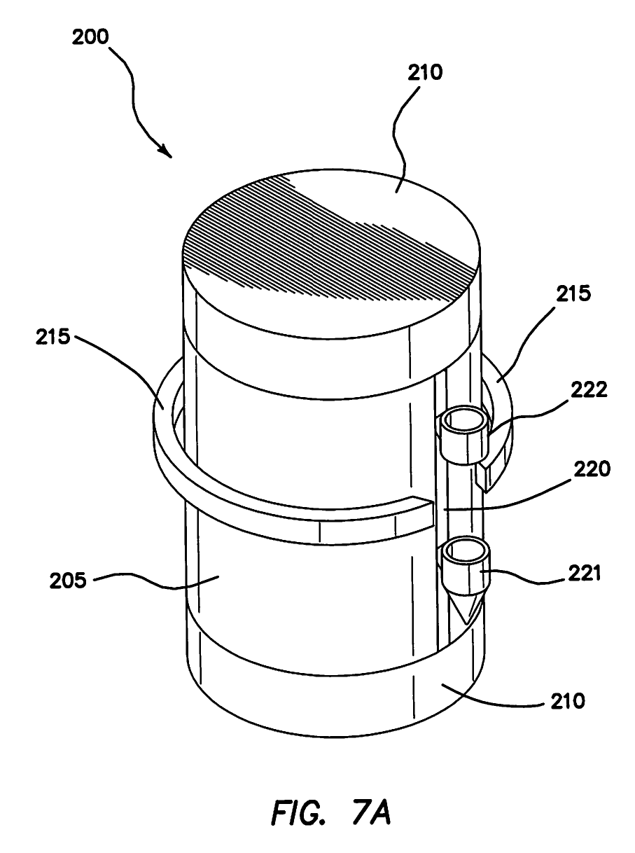

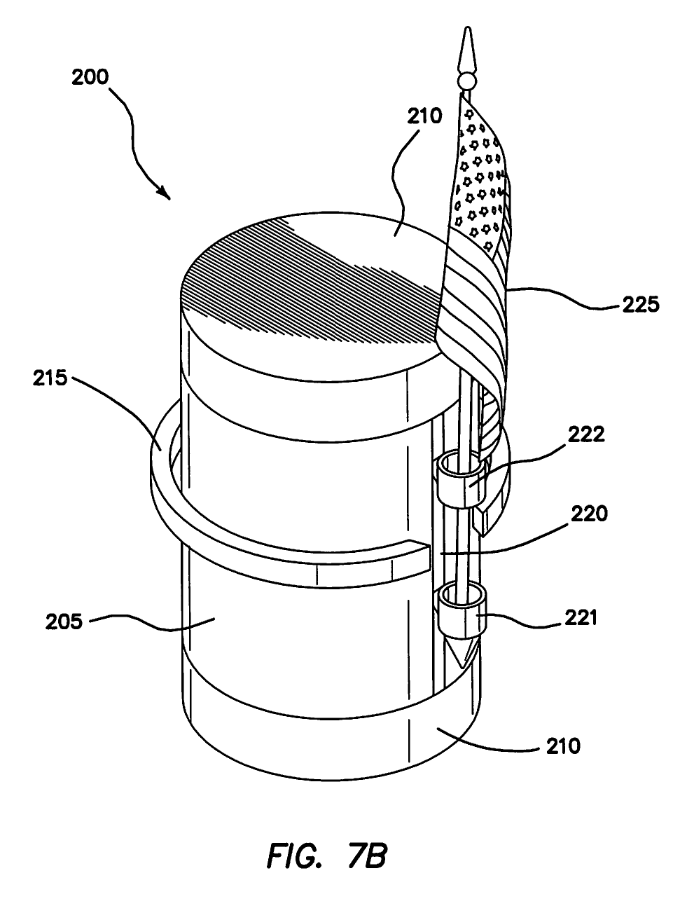

A circular urn 101 is shown in FIG. 5. A housing 111 of the circular urn 101 defines an interior space 121. A threaded opening 131 accommodates lid 190 via threaded portion 195. In this embodiment, a bracket member 151 is symmetric such that multiple urns 101 may be connected to one another or a wall bracket. The bracket member 151 comprises two oppositely positioned, triangular projections 156 which are received by triangular cut-outs 141 in the exterior surface of the urn 101. FIGS. 6a-6b show alternative bracket designs. A first alternative bracket member 152 and flanges 153 are similar to bracket member 151 except for its cross-sectional shape. A second alternative bracket member 154 includes six attachment flanges 155 allowing five items to be attached directly to a subject urn. Those skilled in the art will recognize that any number of bracket designs are possible without departing from the spirit and scope of the present invention.

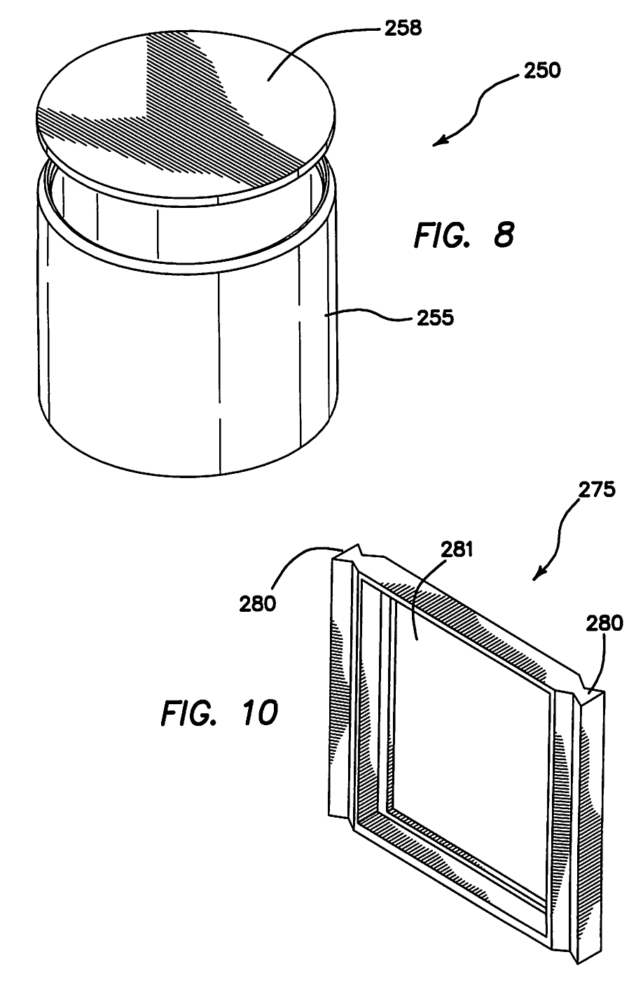

FIGS. 7a-7b show a circular urn 200 having a body 205, ends caps 210, accent rail 215 and holder insert 220. In other embodiments, the accent rail 215 may be adorned with gems, inscriptions and other decorative elements. The holder insert 220 includes a base unit 221 and guide unit 222 configured to maintain flowers, candles, flags and similar elements. FIG. 7b shows a flag 225 maintained by the holder insert 220. The holder insert 220 includes a flange 230 which slides into a cut-out (not visible) in the urn body 205 prior to one or both of the end caps 210 being threaded onto the body 205. In other words, the holder insert 220 may be attached to the body 205 from one or both ends of the body 205 with the corresponding end cap 210 removed.

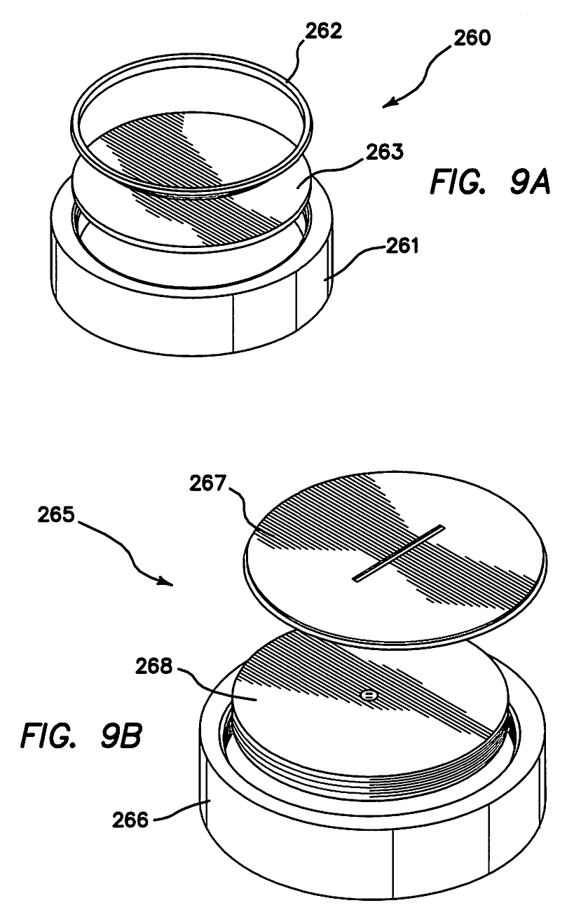

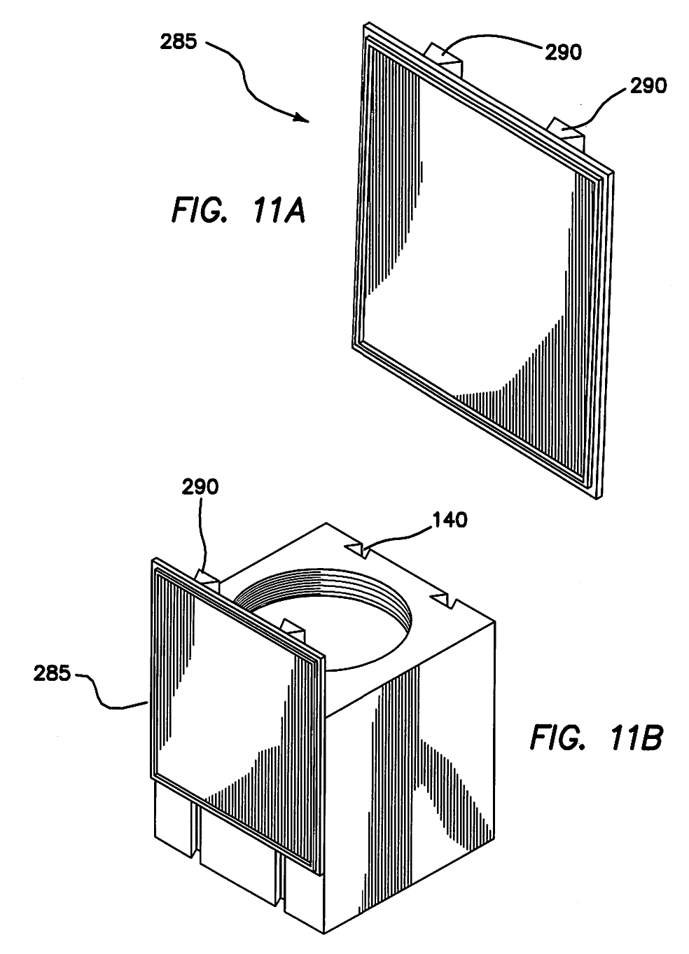

FIG. 8 shows a canister 250 configured to be maintained within a circular urn. Canister has a body 255 with a circular cross-section and a threaded cap 258. The canister 250 is designed to hold artifacts and remains and rest within a circular urn. FIGS. 9a-9b show different end caps 260, 265 designed to retain additional items related to the deceased. The display cap 260 includes a primary ring 261, transparent cover 262 and locking ring 263. This end cap 260 configuration allows a picture, for example, to be displayed in the end cap 260. End cap 265 includes primary body 266 and a laser disk 267 which may be inscribed or engraved with information related to the deceased. For example, the laser disk 267 may be inscribed with medial history, DNA mapping and/or descriptions and images. The laser disk 267 may be attached to an internal surface 268 of the primary body 266 using any means including screws, adhesives, snap fit, etc.

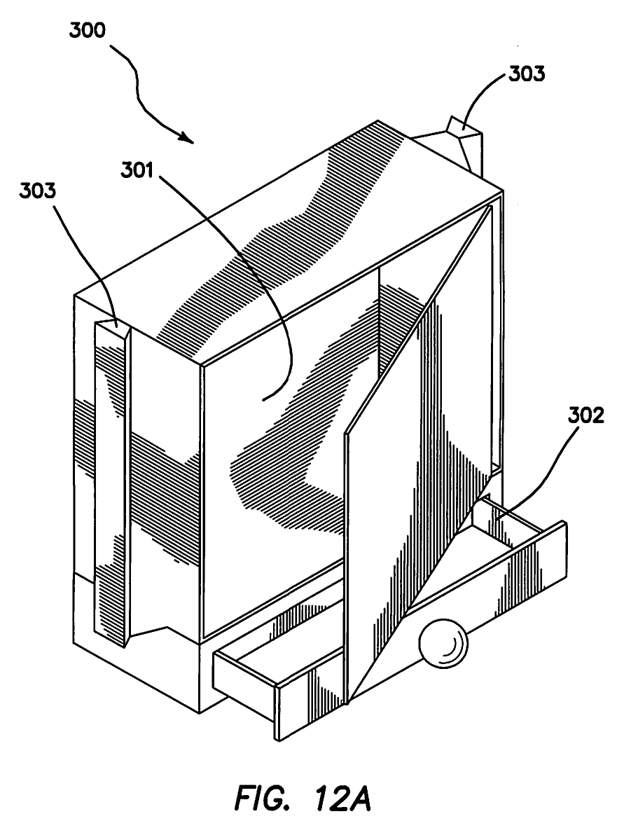

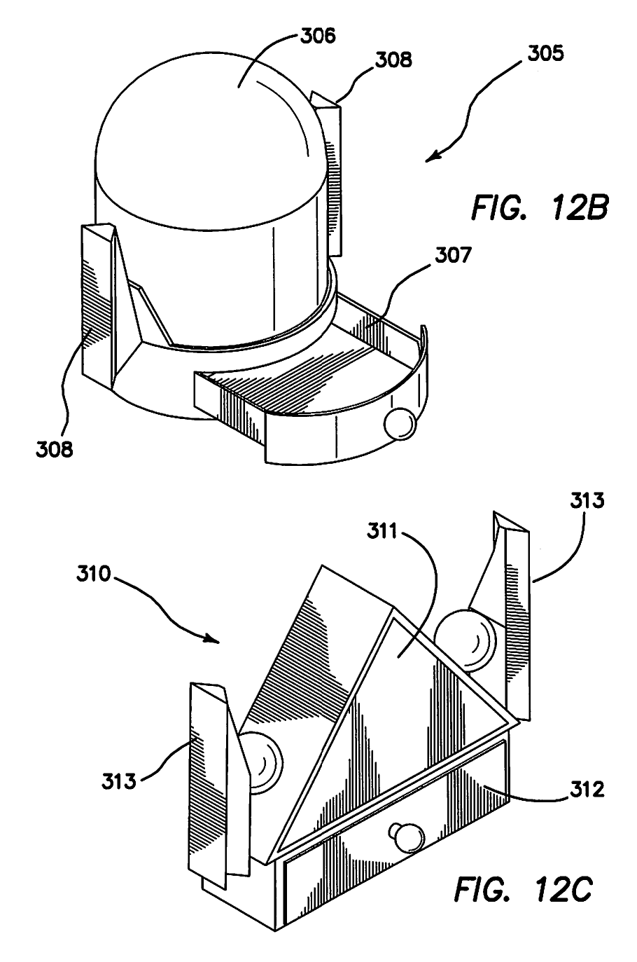

FIG. 10 shows a frame member 275 with flanges 280 on each end of a picture receiving portion 281. The flanges 280 allow the frame member 275 to be connected between two urns or extend freely from a single urn. The frame member 275 is configured to accept a picture. FIGS. 11a-11b show inscription plate 285 having flange members 290. As shown in FIG. 11b the flange members 290 allow the inscription plate to be attached to an urn 100 like that shown in FIG. 1. The inscription plate 285 may be inscribed with memories, pictures and the like related to the deceased.

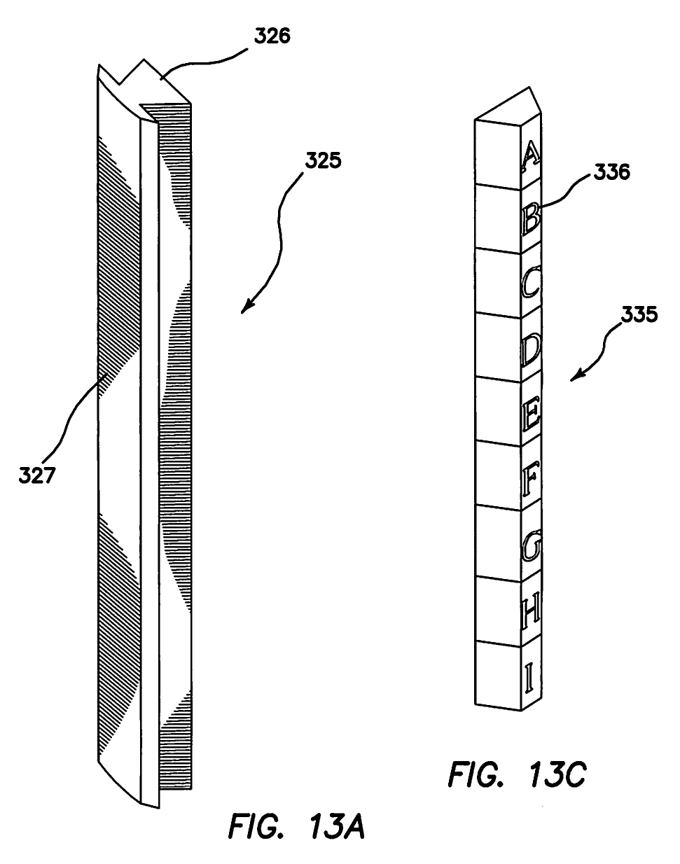

FIGS. 12a-12c show various display cases 300, 305 and 310 which may be connected between two urns or extend from a single urn. FIG. 12a shows a display case 300 including a cabinet/door member 301 and drawer 302 which can both be utilized to store personal items (e.g., medals, media articles, etc.) of the deceased. Flanges 303 provide means for connecting the display case 300 to the urn(s). FIG. 12b shows a display case 305 including a transparent dome 306 and drawer 307 which can both be utilized to store personal items (e.g., medals, media articles, etc.) of the deceased. The transparent dome 306 allows items to be displayed for viewing. Flanges 308 provide means for connecting the display case 300 to the urn(s). FIG. 12c shows a display case 310 including a transparent display case 311 and drawer 312 which can both be utilized to store personal items (e.g., medals, media articles, etc.) of the deceased. The transparent display case 311 allows items to be displayed for viewing. Flanges 313 provide means for connecting the display case 310 to the urn(s).

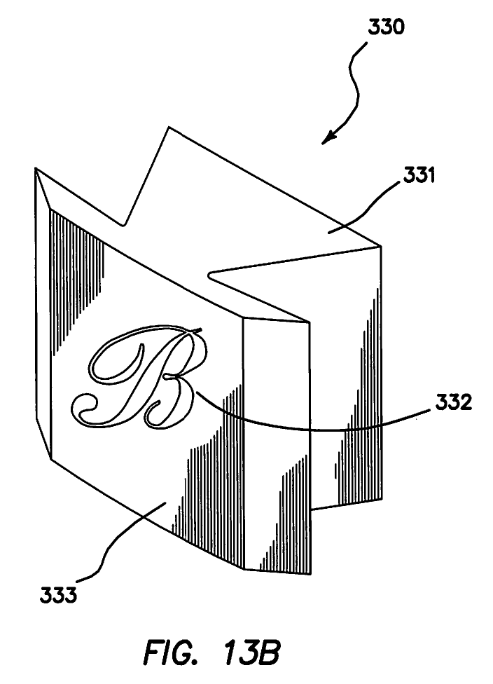

FIGS. 13a-13c show a series of flange inserts. FIG. 13a shows a flange insert 325 including flange 326 which is configured for positioning in an urn cut-out. The face 327 of the flange 325 extends outward sufficiently to rest flush with the urn body creating a clean look. In one embodiment, the face 327 may be engraved with information. FIG. 13b shows a segment 330 including a flange 331 for attaching the segment 330 to the urn. The segment 330 has a letter 332 engraved on a face 333 thereof. Those skilled in the art will recognize that the segment 330 may have any type of symbols including letters, numbers and the like engraved, etched, inscribed or otherwise depicted on the face 333. FIG. 13c shows a series of different segments 335 engraved with letters 336. The segments 335 in combination can be used to spell names and other information on the urn.

Those skilled in the art will recognize that the urns, urn brackets, wall brackets, segments, ends caps and other components may be fabricated of any suitable type of material including metals, alloys, plastics, composites and combinations thereof Moreover, the components may be machined, molded or otherwise formed. While the cut-outs 140 are shown vertically positioned on the exterior surface of the urns, it is apparent that the cut-outs 140 may also be positioned horizontally.

Although the invention has been described in detail with reference to several embodiments, additional variations and modifications exist within the scope and spirit of the invention as described and defined in the following claims.

I claim:

1. An urn comprising:
a housing defining an interior space, said housing having at least one opening for accessing the interior space;
closure means adapted to close said at least one opening; and
one or more cut-outs on one or more exterior surfaces of said housing, said one or more cut-outs configured to receive flanges of secondary members.

2. The urn of claim 1 wherein said closure means is a threaded lid or end cap.

3. The urn of claim 1 wherein said secondary members include the following: urns, segments, display cases, brackets, flange inserts, inscription plates and frames.

4. The urn of claim 1 further comprising a holder insert.

5. The urn of claim 1 further comprising an accent ring.

6. The urn of claim 3 wherein said display case includes one or more of the following: a drawer, cabinet and transparent display area.

7. The urn of claim 1 further comprising a pair of spaced protrusions each defining a slot, said slots configured to receive a decorative article.

8. An urn system comprising:
a first urn connected to one or more of the following secondary members:
one or more additional urns,
one or more segments,
one or more display cases,
one or more brackets,
one or more flange inserts
one or more inscription plates;
one or more frames; and
wherein said connection between said first urn and said secondary members is accomplished by mating flanges of said secondary members with corresponding cut-outs in one or more exterior surfaces of said first urn.

9. The urn system of claim 8 wherein said secondary members include multiple flanges.

10. The urn system of claim 8 wherein said one or more display cases includes one or more of the following: a drawer, cabinet and transparent display area.

11. The urn system of claim 8 wherein said one or more segments depict symbols.

12. An urn comprising:
a housing defining an interior space, said housing having at least one opening for accessing the interior space;
one or more end caps configured to attach to ends of the housing wherein at least one end cap serves to open and close said at least one opening; and
wherein at least one of said end caps is configured to retain items of interest.

13. The urn of claim 12 further comprising one or more cut-outs on one or more exterior surfaces of said housing, said one or more cut-outs configured to receive flanges of secondary members.

14. The urn of claim 12 wherein at least one of said one or more end caps includes a glass cover and locking ring.

15. The urn of claim 12 wherein at least one of said one or more end caps is configured to retain laser disks containing information.

16. The urn of claim 13 wherein said secondary members include the following: urns, segments, display cases, brackets, flange inserts, inscription plates and frames.

17. The urn of claim 12 further comprising a holder insert.

18. The urn of claim 12 further comprising an accent ring.

19. The urn of claim 16 wherein said display cases include one or more of the following: a drawer, cabinet and transparent display area.

20. The urn of claim 12 further comprising a pair of spaced protrusions each defining a slot, said slots configured to receive a decorative article.
